(19) United States
(12) Patent Application Publication
(10) Pub. No.: US 2013/0080316 A1
(43) Pub. Date: Mar. 28, 2013

(54) SYSTEM AND METHOD OF EXPEDITED CREDIT AND LOAN PROCESSING

(71) Applicants: PAUL PAWLUSIAK, WIXON, MI (US); DAVID LOHOEFER, DALLAS, TX (US)

(72) Inventors: PAUL PAWLUSIAK, WIXON, MI (US); DAVID LOHOEFER, DALLAS, TX (US)

(21) Appl. No.: 13/625,796

(22) Filed: Sep. 24, 2012

Related U.S. Application Data
(60) Provisional application No. 61/537,757, filed on Sep. 22, 2011.

(51) Int. Cl. G06Q 40/02

(52) U.S. Cl. 705/38

(57) ABSTRACT

A system and method of expedited credit approval and lending for an applicant initially qualifies the applicant using an input device to obtain predetermined applicant identification information and transmits the applicant identification information to the credit and loan processor computer which verifies the applicant identification without pulling credit. If verified, applicant answers predetermined prescreen question to initially qualify the applicant and the applicant's answer is compared to a predetermined lender criteria for the prescreen question to determine whether to continue with the loan application if the applicant's answer meets the predetermined lender criteria or end the loan application if the predetermined lender criteria is not met, before pulling credit. The applicant is notified of the decision. The credit and loan processor software program continues to qualify the applicant using stated debt to income ratio for a selected loan type and if qualified, then processes full credit application.

### CROSS-REFERENCE TO RELATED APPLICATIONS

This application claims the benefit of U.S. Provisional Application No. 61/537,757 filed Sep. 22, 2011, the entire disclosure of which is incorporated herein by reference.

### BACKGROUND

The present disclosure relates generally to credit application evaluation and loan processing, and more particularly, to an integrated method and system for expeditiously determining the credit worthiness of a borrower and processing a loan using an electronic lending.

### DESCRIPTION OF RELATED ART

When a consumer is interested in financing a prospective purchase of a good or service based on credit, the consumer typically completes a credit application for review by a potential lender. The credit application usually requires the applicant to provide certain sensitive personal information, such as the applicant's social security number, date of birth, or the like. In a retail sales situation, the seller may transmit the completed application to one or more lenders for evaluation. Each of the lenders in turn sends the application to a credit-reporting agency, which for a fee, generates a credit report and associated credit score and provides it to the prospective lender. The information is then transmitted from each of the potential lenders to the seller. The seller then identifies the financing options available to the applicant based on a comparison between the credit report and associated credit score and the lending criteria of various lending institutions.

This conventional credit approval process can be slow, very time-consuming and often results in a significant amount of wasted effort on the part of those involved, especially if the applicant has a poor credit history. Moreover, the process can be costly for the potential lenders, and can adversely affect a consumer's credit score, such as if a credit application is denied or due to multiple “pulls” of the consumer's credit score by different potential lenders. Once the applicant is approved for the loan, then other unrelated parties may be involved in structuring and finally closing the loan.

Thus, there is a need in the art for a faster, more efficient, more cost-effective credit application process that uniformly makes credit determinations earlier in the loan process. Further, there is the need for an integrated system for executing the approved loan.

### SUMMARY

Accordingly, a system and method of expedited credit approval and lending for an applicant initially qualifies the applicant using an input device to obtain predetermined applicant identification information and transmitting the applicant identification information to the credit and loan processor computer which verifies the applicant identification without actually pulling credit. If verified, applicant answers predetermined prescreen question to initially qualify the applicant and the applicant's answer is compared to a predetermined lender criteria for the prescreen question to determine whether to continue with the loan application if the applicant's answer meets the predetermined lender criteria or end the loan application if the predetermined lender criteria is not met, before pulling credit. The applicant is notified of the decision. The credit and loan processor software program continues to qualify the applicant using stated debt to income ratio for a selected loan type and if qualified, then processes the full credit application.

The method also includes the steps of using an automated loan structuring tool associated with the credit and loan processing software program to complete the loan application by the source. The automated loan structuring tool prompts the source to input predetermined information for the loan type and automatically calculates loan structure and notifies the source of adjustments to comply with predetermined rules associated with the selected loan type. The software program sends the funding package for the loan to the source.

A system of expedited credit approval and lending is provided that includes a credit and loan processing software program that is resident on a credit and loan processor computer having a server and a data storage device. The credit and loan processing software obtains predetermined identification information regarding an applicant using an input device, verifies the applicant identification information and if verified continues to process the loan application. The system includes a display device in communication with the credit and loan processor computer for communicating a predetermined prescreen question to the applicant to initially qualify the applicant for a loan. The system also includes an input device for transmitting the applicant's answer to the predetermined prescreen question to the credit and loan processing computer, and the credit and loan processor software program compares the applicant's answer to the prescreen question to a predetermined lender criteria for the prescreen question and communicates via the communications network whether to continue with the loan application if the applicant's answer meets the predetermined lender criteria for the prescreen question and end the loan application if the applicant's answer does not meet the predetermined lender criteria. The predetermined prescreen question is selectively determined to initially qualify the applicant for the loan without consideration of the applicant's credit score and credit history. The system also includes a lender computer in communication with the credit and loan processor computer via a communications network, and the lender provides the credit and loan processor software program the predetermined prescreen questions. The system also includes a source computer in communication with the credit and loan processor computer via a communications network to obtain income and debt information from the applicant using the credit and loan processing software program. The credit and loan processing software program determines a debt-to-income ratio for the applicant by comparing the applicant's debt-to-income ratio to a lender's predetermined debt-to-income ratio rule for the loan and continues the loan application if the lender's predetermined debt-to-income ratio is met and ends the loan application if the lender's predetermined debt-to-income ration is not met.

An advantage of the present disclosure is that the system and method of expedited credit and loan processing provides a faster, more time efficient, more cost-effective credit application process resulting in a faster credit decision. Another advantage is that the system and method of credit and loan processing protects the privacy and interests of the parties involved. Still another advantage is that the system and method of credit and loan processing determines the loan amount the applicant can qualify for early in the process. Still yet another advantage is that the system and method of credit and loan processing automatically structures the deal to comply with lender requirements. A further advantage is that the system and method of credit and loan processing limits any potential adverse effects upon a borrower's credit report if the buyer's credit application is denied. Still a further advantage is that the system and method of credit and loan processing creates an electronic lender that is always available and can selectively handle all facets of the lending process. Yet still a further advantage is that the system and method of credit and loan processing prescreens the potential loan candidate and makes a credit decision without having to pull a credit report from a credit agency. Yet a further advantage is that the system and method of credit and loan processing can simultaneously contract and close the deal upon lender approval.

Other features and advantages of the present disclosure will be readily appreciated, as the same becomes better understood in view of the subsequent description taken in conjunction with the accompanying drawings.

### BRIEF DESCRIPTION OF THE DRAWINGS

The present invention will become more fully understood from the detailed description and the accompanying drawings, wherein:

FIG. 1 is a diagram illustrating a system for expedited credit approval and lending.

FIGS. 2a-2d are a flow chart illustrating a method of credit approval and lending, using the system of FIG. 1.

FIGS. 3a-3m are a series of screen shots illustrating implementation of the method of expedited credit approval and lending of FIGS. 2a-2d in conjunction with the system of FIG. 1.

### DESCRIPTION

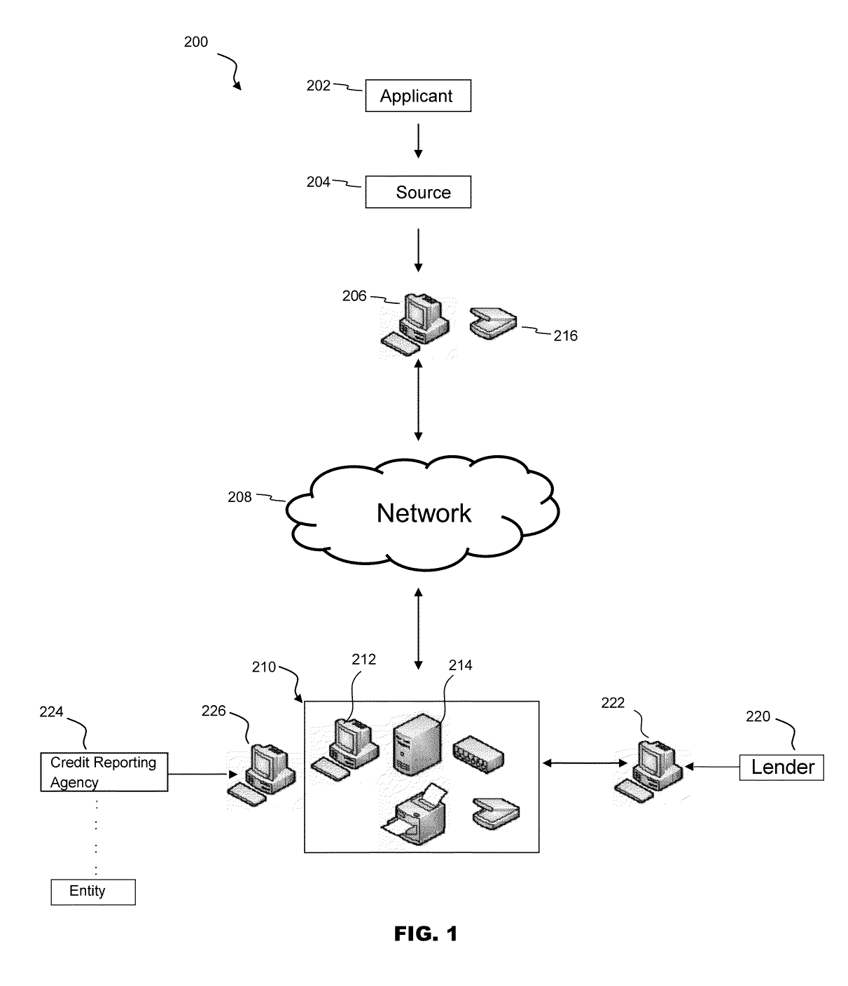

The following description of the preferred embodiment(s) is merely exemplary in nature and is in no way intended to limit the invention, its application, or uses. Referring to FIG. 1, a system for use in credit approval and lending is provided. The system 200 includes an applicant 202, such as a consumer, customer, or other entity desirous of obtaining financing or a loan for some use or purpose, the reason for the loan being non-limiting. An example of a reason is the purchase of a product. The product could be a vehicle, or real property, or consumer good or the like. Another example of a reason is to pay for educational, medical or other types of expenses. The applicant 202 may have a computer. The Applicant's computer has a processor, controller, a database or memory associated with the controller, an input device, output device and display device. The Applicant's computer may be any type of computer device, such as a desktop, laptop, net book, smart phone, personal computer or the like. The applicant's computer may be in communication with a credit and loan processing computer 212 via a communications network 208 in a manner to be described.

The system also includes a source 204 of a good or service. In an example, the source 204 is a seller or retail establishment, such as an auto dealer, furniture store, appliance store, or the like. In another example, the source 204 offers a service, such as medical care, insurance, or education or the like. In a further example, the source 204 offers a financial service, such as a bank, credit union or the like. It should be appreciated that the source 204 and a credit and loan processor 210 could be one in the same.

The system includes a source computer 206 having a processor, controller, a database or memory associated with the controller, an input device, output device and display device. Data relevant to the transaction may be stored on the source database. The source computer 206 may be a single computer or a series of networked computers in communication with one another. The source computer 206 is in communication with a credit and loan processing computer 212 and other computers in the system via a communications network 208.

The input device 216 may be any type of data input device such as a keyboard, mouse, voice recognition device, optical device or the like. An example of an optical device is a scanner that optically reads an image and converts the image into digital or electrical content. Similarly, the input device may a bar code reader that reads a magnetic strip and converts the information into electrical content.

The communications network 208 may be wired or wireless, or a combination thereof. Examples of a communications network includes, a telecommunication network, a line-connected network, a wireless communication network, such as an intranet or the Internet, a local area network (LAN), wide area network (WAN), virtual private network (VPN), a digital communication network or system, a personal communication services (PCS) network or system, a satellite communication network, a broad band communication network, a radio communication network, any other communication network or system or combination thereof, and the type of communication network is non-limiting.

The credit and loan processing computer 212 may be a server having a processor, controller, a database or memory associated with the server, an input device, output device and display device. Data relevant to the transaction may be stored in the database. The credit and loan processing computer 212 may be one or a series of networked computers in communication with one another. The credit and loan processing computer 212 can provide control over the system and may perform any of the various processing services and/or functions to be described herein. Further, the credit and loan processing computer 212 can provide services for any of the other system computers, and may facilitate communications between such computers. In this manner, data and/or information transfer between any of the such computers may be in a bi-directional manner.

An expedited credit and loan processing software program 214 is resident on the credit and loan processing computer 212. The credit and loan processor 210 provides lending services to the provider 204 via a completely automated turnkey lender management platform (LMP) providing user customizable credit decision making and loan processing. Advantageously, the LMP may move a potential loan from application to maturity all within one system.

The system 200 further includes a lender 220 having the ability to loan the applicant capital, or otherwise provide funding. The credit and loan processor 210 may interact with multiple lenders 220 in structuring the loan. The lender 220 likewise has a lender computer 222 associated therewith. The lender computer 222 may have a processor, controller, a database or memory associated with the controller, an input device, output device and display device. Data relevant to the transaction may be stored on the lender database. The lender computer 222 may be a single computer or a series of networked computers in communication with one another. The lender computer 222 is in communication with the credit and loan processing computer 212 and other computers in the system via a communications network, as previously described.

The credit and loan processor 210 may be in communication with others entities 224 involved in the lending process via an entity computer 226, such as a credit reporting agency and associated credit reporting agency computer that compiles and reports credit scores for an individual. The entity computer 226 is similarly in communication with the other computers and such communication can be across the previously described communications network 208. The credit and loan processor 210 is flexible and can accommodate various aspects of the credit application process and parties involved, such as lenders 220, new programs and changes to existing programs and/or tiers, vendors, dealers, loan servicing, investors, or the like. The loan itself can be associated with any type of retail, leasing, LHPH or BHPH transaction, and the nature of the transaction is non-limiting. Advantageously, features may be built into the platform to assist with saving the lender money from filtering the applicant with pre-screen questions to analyzing criteria such as debt to loan ratio (DTI) prior to pulling credit. New loan programs can be added and changes to existing programs and/or tiers, can be made at any time by the lender 220 or source 204. The credit and loan processor 210 facilitates these additions and changes so they are completed within days rather than months as typical in conventional credit application process and systems.

Others features associated with the lending process may be utilized by the credit and loan processor 210. These include, but are not limited to: Extended Service Contracts, Credit Life, Accident and Health, Maintenance, GAP, VSI, etc. In an example of a source 204 that is an auto dealer, the credit and loan processor 210 has the capability of importing dealers that are currently signed with an organization. Alternatively, the credit and loan processor 210 can facilitate in generating new sources, i.e. dealers, for a program.

The credit and loan processor 210 can provide loan servicing, i.e. back up or primary loan servicing. For example, the credit and loan processor 210 can incorporate features such as taking the loan after funding, boarding the loan, facilitating consumer payments, collecting receivables, assuming compliance responsibilities, handling any claims, handling repossessions, collateral disposition, bankruptcies, consumers calls, including payoff information, or the like. The credit and loan processor 210 may also maintain real access to portfolios with the ability to auto evaluate loan to value in real time.

The credit and loan processor 210 may interact with other entities 224. An example of another entity is a government database such as OFAC, or the post office, or a license bureau and the selection is non-limiting. An example of another entity is an investor. For example, real time portfolio valuations can be pulled if the loan is underwritten by the credit and loan processor and stored in a database associated with the credit and loan processing computer. Should an investor desire to sell all or a portion of their portfolio, the investor need only to choose the date range of the portfolio and click “offer for sale”. The deals may be offered for bid by an investor pool with the investor's consent. The investor can have the opportunity to choose the best bid. Advantageously, the sales process is reduced as the due diligence is already done. Once the new investor purchases the portfolio and the lender has been funded, titles to the new entity are automatically transferred, where applicable. This could be done with servicing released or retained.

In another example, the credit and loan processor 210 may selectively accommodate portfolio transactions in real time, break them down into segments of credit tiers and scores, re-evaluate values on the fly and provide spreadsheets to potential buyers of the portfolio. Additionally, the credit and loan processor 210 can accommodate a pool of potential investors where bids for the originator can be obtained if desired. Thus, the use of multiple platforms for originating, booking, servicing, and selling (where applicable) loan portfolios is avoided.

The credit and loan processing software program 214 may include user selectable features that are implemented in a manner to be described. The user selectable features may be incorporated in modules, to enhance the flexibility of the program 214. Examples of user selectable features include: prescreen, application, DTI calculation before credit is pulled, valuation of collateral, deal structure to fit compliance with all programs and tiers, electronic funding packages (contract form warranty), electronic and mirrored funding process, document storage, auto update statuses, view contract in transit, full servicing or back up servicing, portfolio sales, compliance with OFAC, Red Flag, and consumer notification letters, adverse Credit letters, text messaging and email, note section (all communication automatically stored within the deal), lender override capabilities, VIN decoder, forms Library, custom forms, reports (Look to book, dealer activity, marketing activity, loan processor performance, expired deals (auto expire in 30 days), outstanding approvals not contracted, penetration by program and tier, complete deal status and recap., etc. The credit and loan processing software program 214 may also include a reports module which can provide the stored data in a user configurable format, i.e. range, back end product, etc.

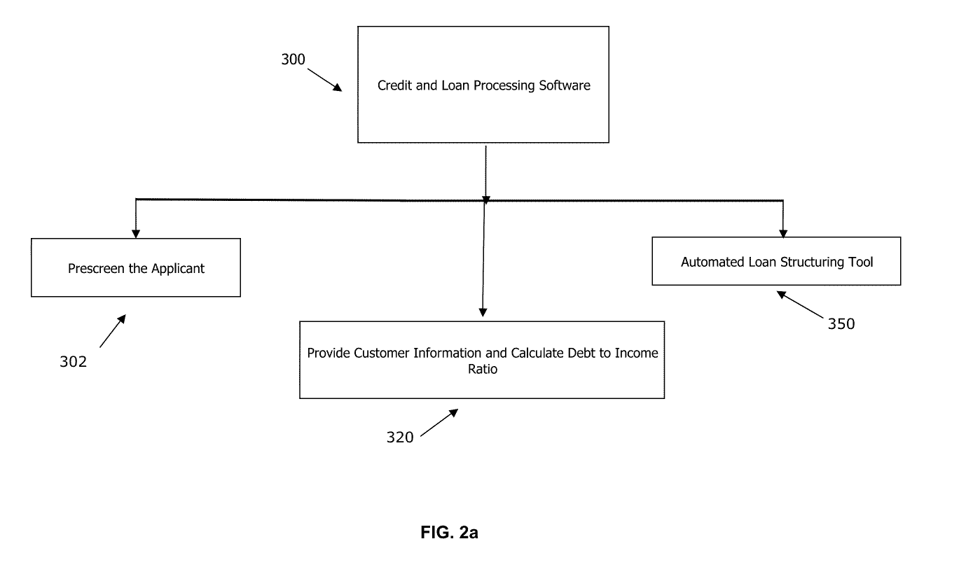

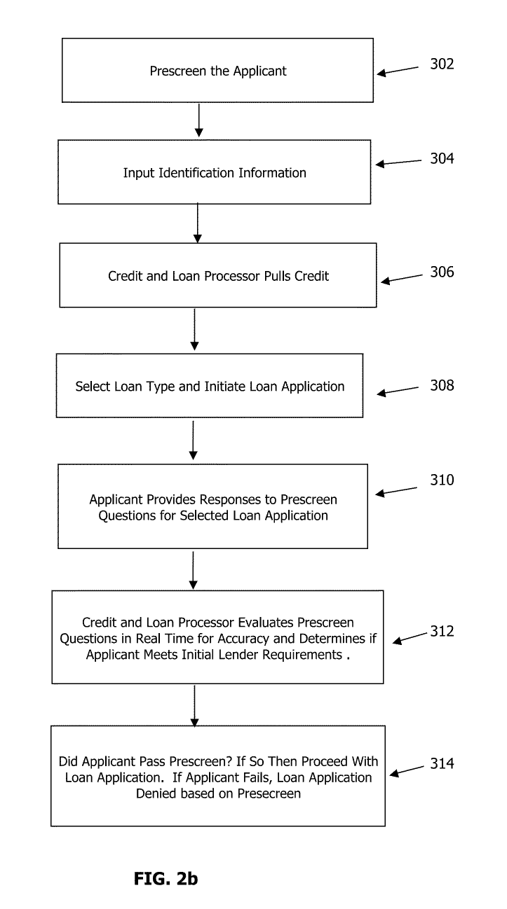

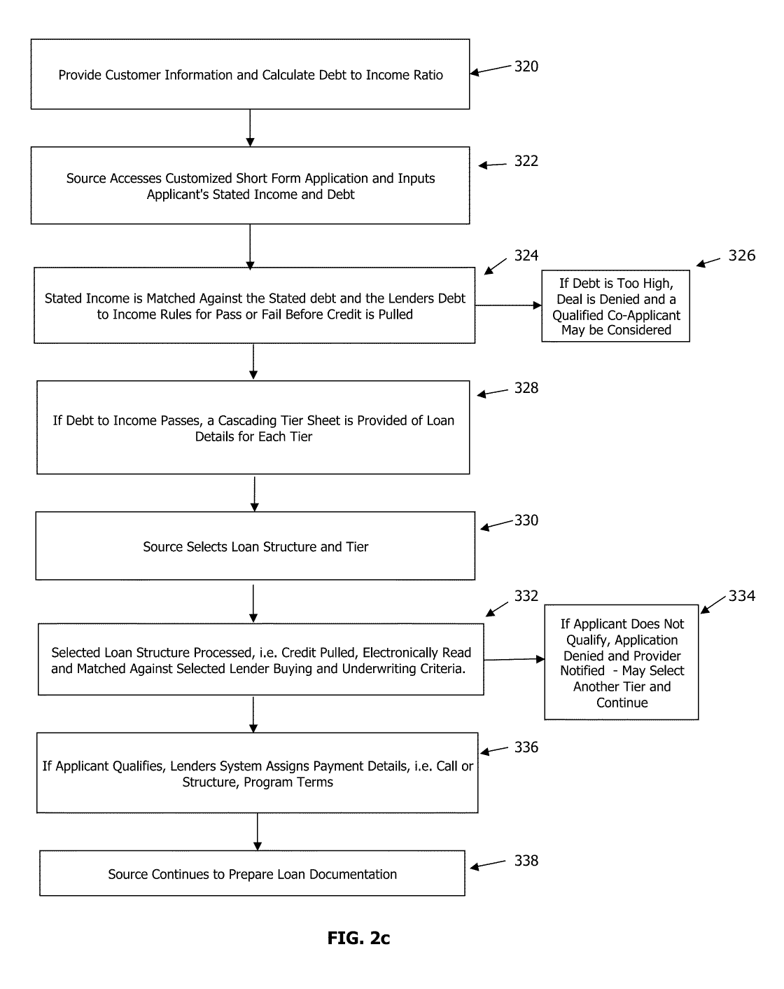

Referring to FIGS. 2A through 2D, a flowchart illustrating a method of expedited credit approval and lending is shown using the system of FIG. 1. The method is implemented using a custom designed lender software program that incorporates lender-specific modules for the source 204 or lender 220 or other entity 224. Advantageously, the modules may be programmed for complete automation. Examples of source 204 selectable modules includes custom templates for prescreen, debt-to-income calculations, credit underwriting, or the like. Another example of a module is a security module, such as for assigning user id's and passwords. The modules can be implemented in a user selectable manner.

Examples of customized lender-specific modules or components may pertain to the following: originations, credit, automatic decisions, automatic structure, electronic ID and signature, automatic contracting, electronic funding verifications, item valuations, full servicing or back up, portfolio sales, electronic search features to locate applicants, automatic status updates, reports including real-time reports, built-in email, text, and messaging, or the like.

The method may be utilized with any type of transaction. In a non-limiting example to be described, the transaction is a loan for the sale of a vehicle. In such an example, the applicant 202 is a vehicle buyer and the source 204 is an automotive dealer. However, the method is applicable to any transaction for value.

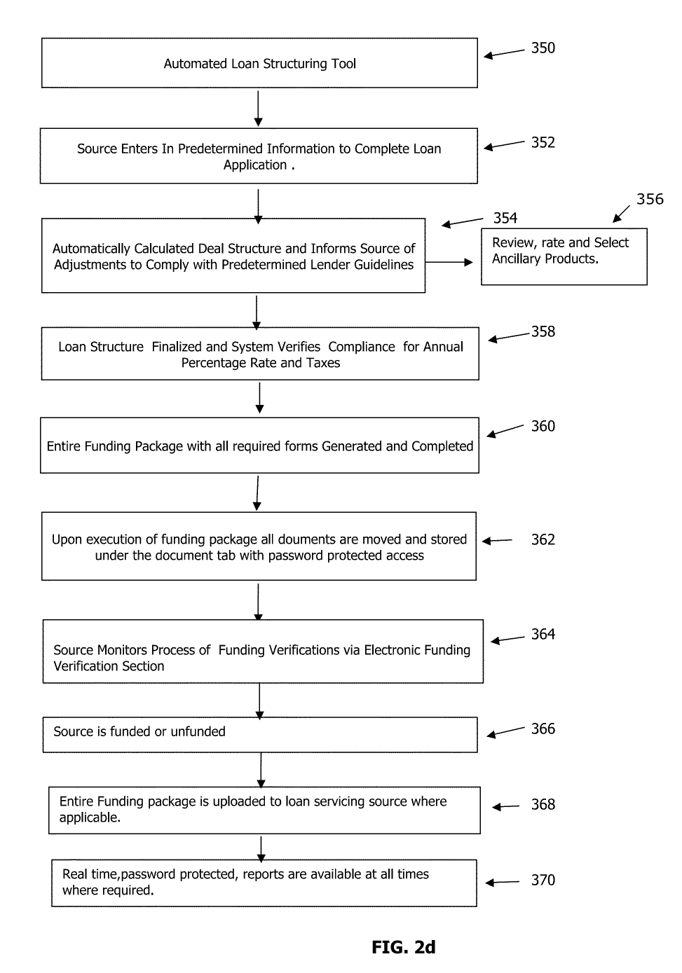

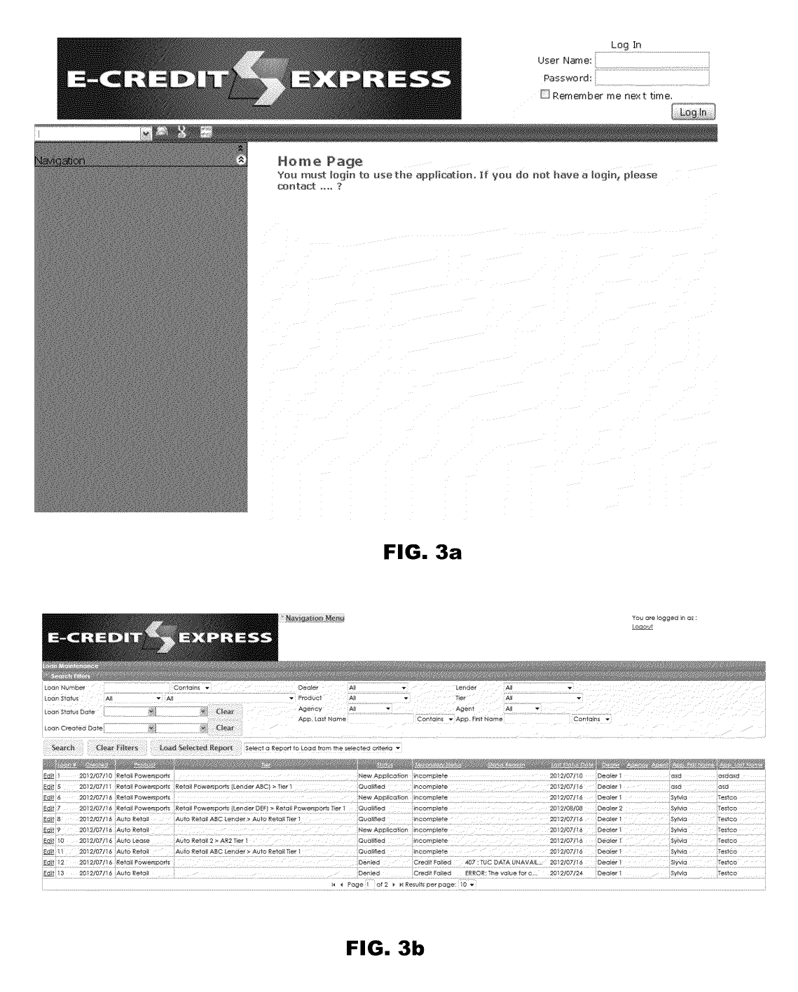

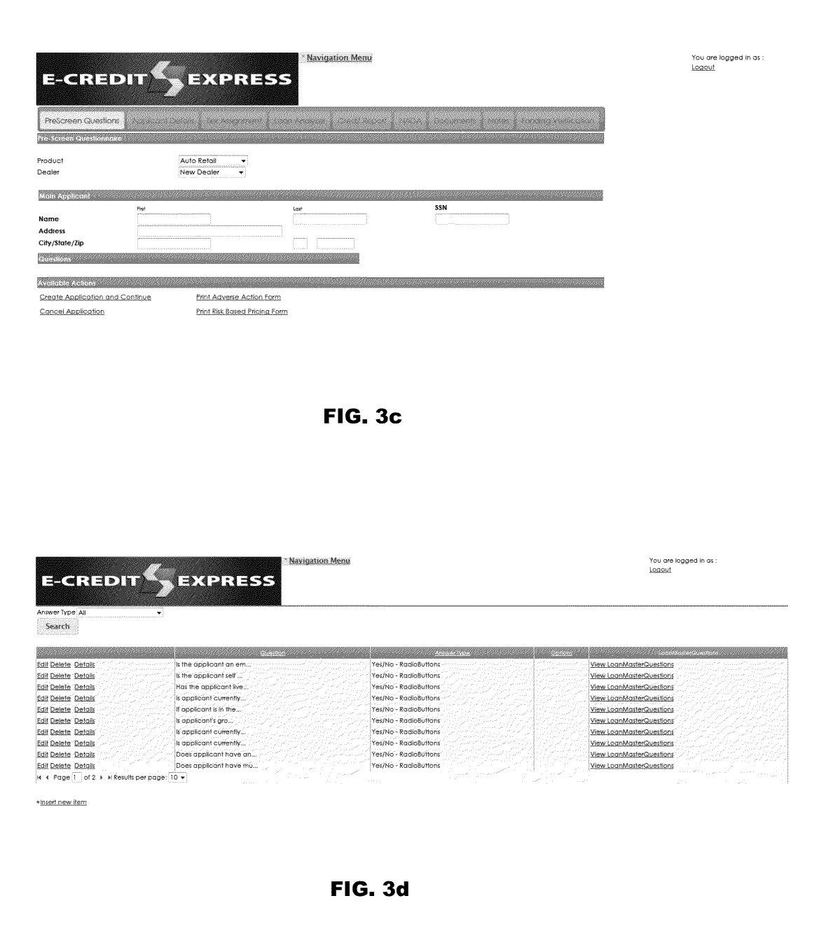

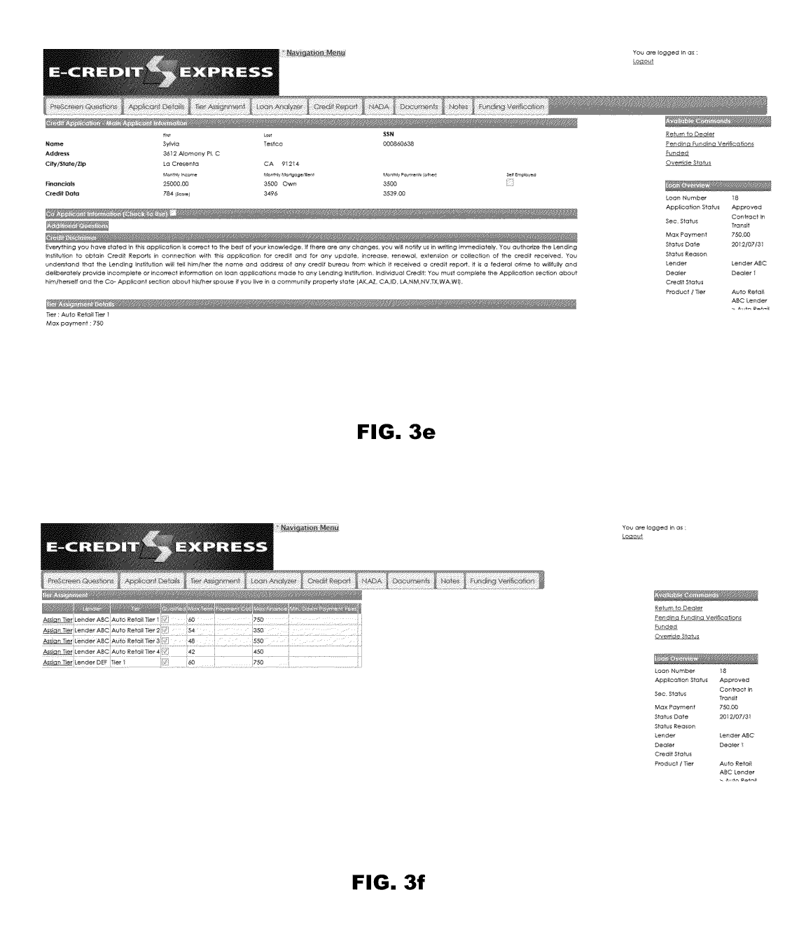

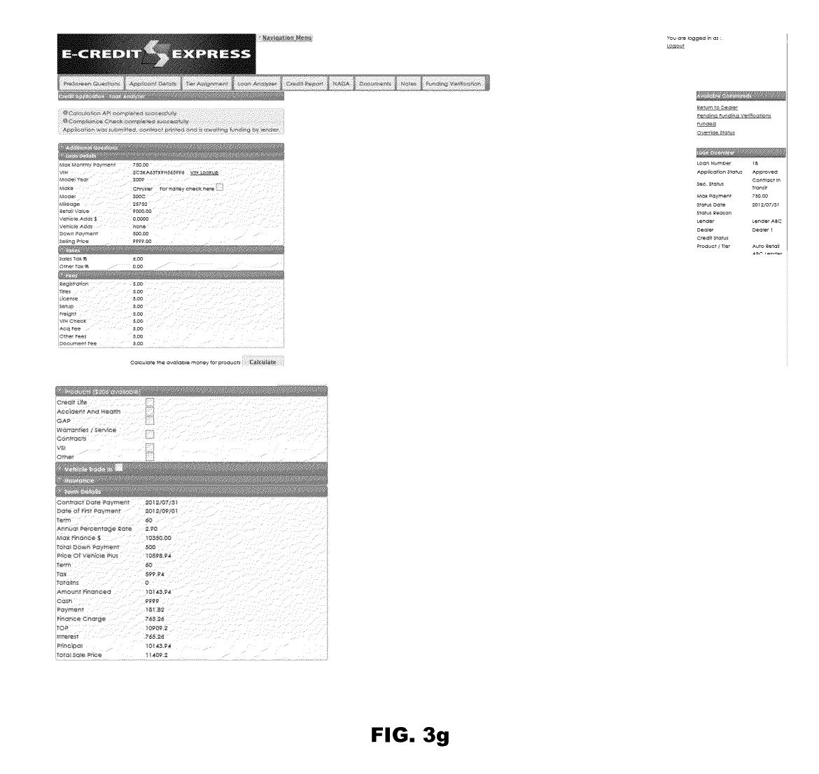

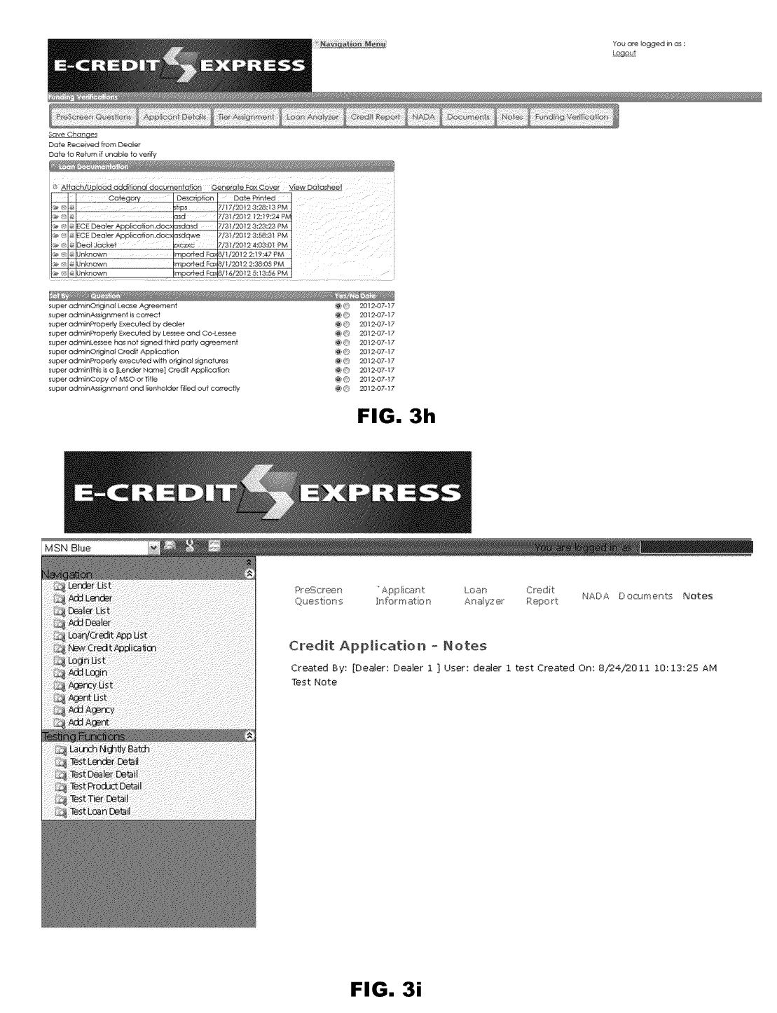

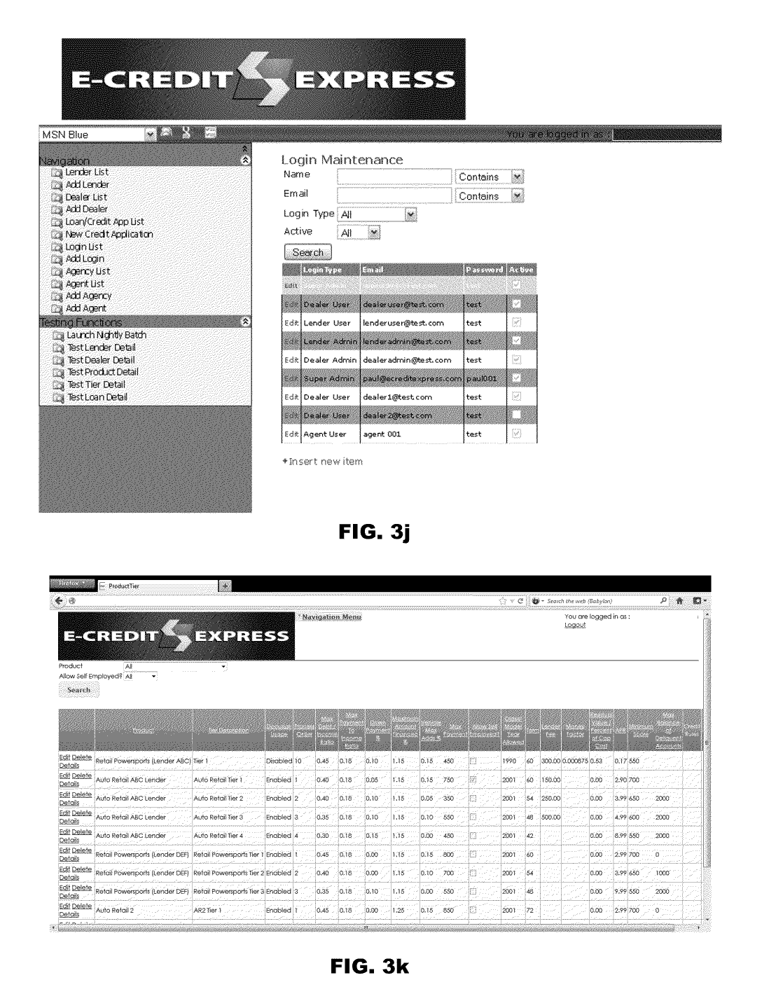

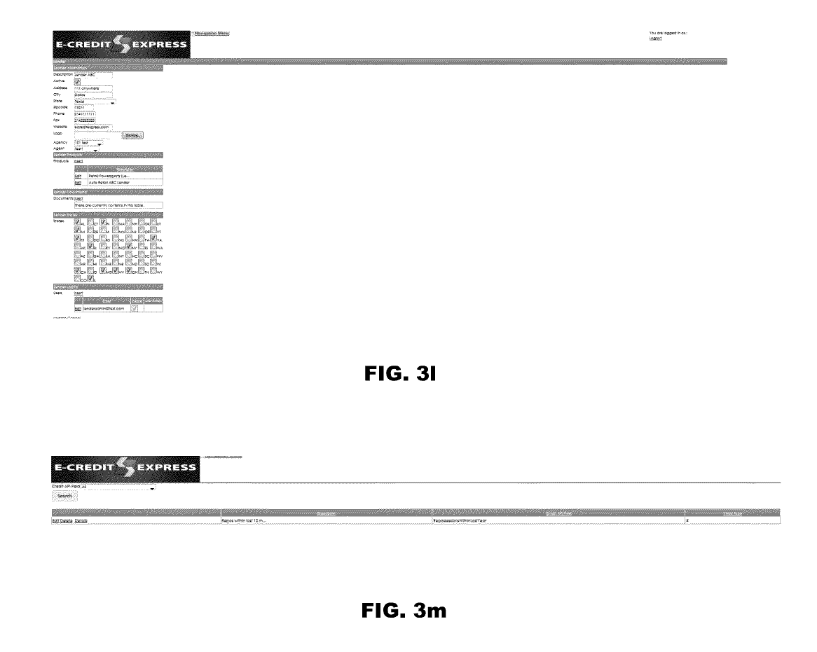

The method begins in block 300 with the step of the providing the applicant 202 access to the credit and loan processing software 214. The order of steps shown is by way of example, and the steps may be varied for a particular example. Such access may be provided by the source 204 using the source computer device 206 as previously described. Alternatively, access may be provided directly to the applicant 202 using an applicant computer device (not shown), so that the applicant 202 is prescreened and preapproved prior to contacting the source 204. For example, the applicant 202 or source 204 is presented with a home page for access or log in purposes as shown in FIG. 3a. The user may be prompted to enter a User Name and password. Different users may be assigned a predetermined level of access, i.e. administrator or loan. As shown in FIG. 3b, the source may select a Loan/Credit App tab and will be provided with a page summarizing the status of transactions. The status may change as updates are made by the credit and loan processing software program 214. Advantageously, the system is always available and is searchable. Customized reporting may also be available.

The method advances to block 302 and the prescreen of the applicant 202 is initiated. An agent of the source 204 or the applicant 202 may initially access the credit and loan processing software 214 in order to perform the prescreen. The method advances to block 304 and the applicant is prescreened. As shown in FIG. 3c, the user may selectively be provided with a page and identification information pertaining to the applicant 202, and such information is provided as an input to the credit and loan processing software 214. The identification information may be input automatically or manually via an input device associated with either the applicant computer device or source computer device 206. In example, the identification information is the applicant's name, address, date of birth, drivers license number, or other such identification number, phone number or the like. The identification information may be automatically entered such as by scanning a driver's license or identification card using an electronic data reader 216.

The method advances to block 306 and the credit and loan processor may optionally perform a “soft” credit pull based on the provided identification information. The soft credit pull merely verifies the identification information provided using publicly available information. It should be appreciated that the soft credit pull does not involve accessing a credit reporting agency that maintains credit reports and compiles a credit score for an individual based on their particular credit history. If the identification information is verified, the methodology advances to block 308 and the applicant is provided with loan types from lenders 220 relevant to the transaction and the loan application is initiated.

The methodology advances to block 310 and includes the step of selecting the loan type for the applicant 202. The applicant 202 may be provided with predetermined prescreen questions relevant to the loan type. Referring to FIG. 3d, an example of a page such as on a display screen associated with the applicant computer device or source computer device is illustrated with prescreen questions. Examples of prescreen questions include whether the applicant is employed, how long the applicant has lived at the given address, or the like. The prescreen questions may be maintained within a database associated with the credit and loan processing software program 214, and the particular prescreen questions may be selected based on a particular circumstance. By evaluating the prescreen questions early in the process, costs associated with the loan process are avoided. Such filtering is done prior to pulling a credit report, for the benefit of the applicant and lender to avoid duplicative credit inquiries.

The method advances to block 312 and includes the step of evaluating the response to the prescreen questions by the credit and loan processor 210. The prescreen questions are monitored and performance tracked in real time by the credit and loan processor 210. It should be appreciated that the prescreen questions may be lender specific and may be updateable. The response to the prescreen question may be sent to the lender 220 for evaluation, or evaluated by the credit and loan processor 210 based on lender specific criteria. For example, the lender specific prescreen questions may have to be answered correctly in order to proceed.

The method advances to block 314 where it is determined whether the applicant 202 passed the prescreen question. If the applicant 202 passed, the loan application continues. If the applicant does not pass the prescreen, then the loan application is denied based on the prescreen. Advantageously, the applicant has been evaluated without the need to check the applicant's credit score. The applicant could secure a co-applicant and begin the prescreen process again. The co-applicant is prescreened in a similar manner as the applicant.

If the applicant passes the prescreen, the method advances to block 320 and continues with the steps of providing additional applicant information and determining a debt to income ratio for the applicant 202. The method advances to block 322 and includes the step of the source accessing a short form loan application that obtains information from the applicant 202 regarding the applicant's income and debt. For example, after passing the initial prescreen questions, applicant or source may be provided with an applicant information screen as shown in FIG. 3e. The applicant information screen represents a customized short form application which includes entry of applicant information, such as stated gross income, monthly payments, or the like.

The method advances to block 324 and includes the step of the credit and loan processor 210 reviewing the applicant's stated income against the applicant's stated debt and establishing a debt to income ratio for the applicant 202. The credit and loan processor 210 than compares the applicants debt to income ratio against a particular lender's 220 predetermined debt-to-income criteria to initially determine the credit worthiness of the applicant 202. If should be appreciated credit worthiness is initially evaluated based on debt to income ratio, and that the credit report for the applicant has not yet been pulled. Since most declined transactions are due to income, the credit application is denied early and reduces cost to the lender.

If the applicant's debt to income ratio does not meet the predetermined debt to income criteria, the method advances to block 326 and the loan is denied. At this point, the applicant 202 may locate a co-applicant, and the method begins again in block 302 with the step of prescreening the applicant 202 and the co-applicant. Co-applicants may be qualified using the prescreen to insure that the co-applicant is likewise qualified. Alternatively, if the applicant passed the prescreen, a different loan type or tier or lender may be selected and the method continues to qualify the applicant.

If the applicant's debt to income ratio meets the lenders criteria, the method advances to block 328. In block 328 the loan application continues and the source is provided with predetermined loan information. Referring to FIG. 3f, the user may be provided with a page describing loan information, such as a Cascading Tier Sheet. The Cascading Tier Sheet includes details regarding each tier such as rate, term, fees, discounts, advances, stipulations, advance amounts, down payment requirements or the like for a particular loan product. Advantageously, the source may review the details of potential approvals to make sure that the transaction will be feasible versus just sending the file to group of lenders at one time in a “shot gun” approach. This eliminates the need to unnecessarily pull credit reports, which is costly for the lender and could impact the applicant's credit rating.

The method advances to block 330 and includes the step of the source 204 selecting the loan structure and tier. Referring the FIG. 3f, an example of a page for selecting the tier is illustrated. If the loan is declines, the source may select the next tier and continues.

In the example of a loan for an automotive vehicle, the source may enter the potential Vehicle Identification Number, and the credit and loan processor may look up additional information regarding the potential vehicle from another entity and include that information in the loan application. Such information may include vehicle year, make, model, mileage or the like. The ability to auto fill information may eliminate errors due to manual data entry.

The methodology advances to block 332 and the applicant's loan application is formally processed by the credit and loan processor 210. Referring to FIG. 3g, an example of a page for structuring the transaction is illustrated. To process the loan, the credit and loan processor pulls the credit for the applicant. The credit history of the applicant, including credit score, may be obtained from one of the recognized credit reporting agencies, such as Transunion or Equifax or the like. The credit and loan processor 210 may evaluate the credit worthiness of the applicant 202 by matching the applicants credit data, such as credit history, credit score, debt to income ratio or the like against a particular lenders buying and underwriting criteria.

If determined that the applicant does not qualify for the loan, the method advances to block 334 and the application is denied. The credit and loan software program may automatically generate an adverse action letter for use by the source. Alternatively, the source may select another loan tier for consideration. Advantageously, potentially adverse transactions are not presented to the lender, which improves the lender's “look to book”.

If determined that the applicant does qualify for the loan, the method advances to block 336 and the application is approved. For example, the lender 220 may assign a payment call and/or structure along with a loan program and tier assignment. Advantageously, the credit and loan processor 210 has made an initial credit decision without pulling credit from a credit reporting agency and actual credit is pulled only at the time if and when the debt-to-income passes the predetermined rules and the transaction has been accepted and purchase decision finalized. The method advances to block 338 and the source 204 continues with preparing the approved loan documentation for the particular lender 220.

The method advances to block 350 and an automated loan structuring tool is implemented for structuring the transaction. The method advances to block 352 and the source enters predetermined information to complete the loan application. For example, the source 204 may be presented with a screen on the display device for entering information. Examples of predetermined information includes collateral information along with selling price, down payment, tax rate (sales and use tax up front if a lease is being purchased), other related fees, or the like.

The method advances to block 354 and the credit and loan processing software program automatically calculates the deal structure. The credit and loan processor may notify either the source or lender of any adjustments that may need to be made to the transaction to comply with any predetermined lender guidelines. The method may advance to block 356 and the source may be provided with a display screen illustrating available additions to the loan representing ancillary products. Examples of ancillary products includes extended service agreements, insurance, warranties or the like. Any pricing, terms or other information associated with the ancillary product will be provided to the source and applicant. If selected, such ancillary products are included with the transaction. Ancillary products and related contract forms for products may be stored and accessible through the credit and loan processing software program and not called through a series of API's as is presently done.

The method advances to block 358 and includes the step of finalizing the loan structure and verifying compliances with the predetermined lender guidelines and other rules such as Annual Percentage Rate and Taxes. The source, credit and loan processor or lender may perform such verification.

The method advances to block 360 after compliance is confirmed, and the step of generating the loan funding package is performed. For example, the source may select a generate contract module. At this point the applicant completes a detailed credit application and other information specific to a given lender and transaction. Alternatively, the loan forms associated with the funding package can be executed in a conventional manner with the lender for funding purposes.

If the generate contracts module is selected, the methodology advances to block 362 and the funding package is stored under a “Documents” tab in the credit and loan processing software program 214. Access to the funding package may be password protected to offer security to the applicant, source of lender. The lender continues to process the loan. The source may electronically provide additional information to the lender as necessary, and the additional information is automatically associated with the funding package for the transaction. The method advances to block 364 and includes the step of the source monitoring the process of funding the loan by accessing an electronics funding verification page maintained by the credit and loan processor 210. An example of a page illustrating electronics fund verification is illustrated in FIG. 3h. The lender may update the status of due diligence of the funding package and may provide the source any status. The method advances to block 366 and the source is funded. If there is a problem, such as with the provided information, the source may not be funded. The method may advance to block 368 and includes the step of uploading the funding package to a loan servicing source. The method advances to block 370 and the transaction is complete.

The credit and loan processing software program may provide additional features, such as an electronic signature for all documents. The loan paperwork may be maintained in an electronic file associated with the transaction. Reports may be available at any time. It is contemplated that the particular steps described with respect to the method may be implemented in another order. Referring to FIG. 3i, a page illustrating a notes section is provided. The notes section allows for two-way communication between the source, credit and loan processor and lender. The notes are maintained with the electronic file associated with the transaction. Referring to FIG. 3j, a page illustrating an example of administrative functions is illustrated. The source may control who has access to the credit and software program. Referring to FIG. 3k, a page illustrating an example of adding products or tiers is illustrated. The lender may have several products or tiers that they finance. The credit and loan processor may change products according to a particular need, such as customize for a particular state. Referring to FIG. 31, a page is illustrated demonstrating how the credit and loan processor may add lenders, adjust tiers, insert pre-screen questions or documents that are specific to a type of transaction. Further, ancillary products and advance amounts for each may be added. Referring to FIG. 3m, a page illustrating a database for credit decision rules resides within the credit and loan software program. Credit decision rules are maintained for a particular lender and are applied in analyzing a particular transaction.

The system and method of the present innovation can be utilized in numerous preferred embodiments in order to provide a vast array of financial and financial-related services for any one or more of the various parties or entities described herein. While the embodiments may be described with regards to utilization by a particular party or entity, it is important to note that any of the parties and/or entities described herein may utilize the present innovation in the same, similar and/or analogous manner.

Many modifications and variations of the present disclosure are possible in light of the above teachings. Therefore, within the scope of the appended claim, the present disclosure may be practiced other than as described. The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of expedited credit approval and loan processing for an applicant, the method comprising the steps of:
(a) providing a credit and loan processing software program that is resident on a credit and loan processor computer having a server and a data storage device;
(b) obtaining predetermined identification information regarding an applicant using an input device and transmitting the applicant identification information to the credit and loan processor computer;
(c) verifying the applicant identification information by the credit and loan processing software and if verified continuing to consider the applicant for a loan and if not verified notifying the applicant that they will not be considered for the loan;
(d) communicating a predetermined prescreen question to the applicant to initially qualify the applicant for the loan using a display device in communication with the credit and loan processor computer;
(e) submitting the applicant's answer to the predetermined prescreen question to the credit and loan processing computer, and the credit and loan processor software program compares the applicant's answer to the prescreen question to a predetermined lender criteria for the prescreen question;
(f) determining by the credit and loan processor software whether to continue with the loan application if the applicant's answer meets the predetermined lender criteria for the prescreen question or end the loan application if the applicant's answer does not meet the predetermined lender criteria; and
(g) notifying the applicant whether the application will be continued by the credit and loan processor software program.

2. The method of claim 1 further comprising the steps of:
(a) providing a source computer that is in communication with the credit and loan processor computer via the communications network;
(b) obtaining income and debt information from the applicant using the credit and loan processing software program;
(c) determining a debt-to-income ratio for the applicant by the credit and loan processing software program;
(d) determining if the applicant's debt-to-income ratio meets a lender's predetermined debt-to-income ratio rule for the loan by the credit and loan processing software program and continuing the loan application if the lender's predetermined debt-to-income ratio is met and ending the loan application if the lender's predetermined debt-to-income ratio is not met;
(e) selecting a loan type by the source to continue the loan application, wherein the loan type is provided to the source by the credit and loan processing software program;
(f) obtaining the applicant's credit report from a credit reporting agency in communication with the credit and loan processor computer;
(g) determining if the applicant's credit report meets predetermined criteria for the selected loan type by the credit and loan processing software program; and
(h) approving the loan to the applicant for the selected loan type by the credit and loan processor if the applicant's credit report meets predetermined criteria for the selected loan type and denying the loan to the applicant if the predetermined criteria for the selected loan type is not met and communicating whether the loan is granted or denied to the source via the communications network.

3. The method of claim 1 further comprising the steps of:
(a) using the predetermined prescreen questions to initially qualify a coapplicant using the credit and loan processing software program.

4. The method of claim 1 further comprising the steps of:
(a) selecting another loan type if the loan to the applicant for the selected loan type is denied using the credit and loan processing software program.

5. The method of claim 1 further comprising the steps of:
using an automated loan structuring tool associated with the credit and loan processing software program to complete the loan application by the source, wherein the automated loan structuring tool:
(a) prompts the source to input predetermined information for the loan type;
(b) automatically calculates a loan structure and notifies the source of adjustments to comply with predetermined rules associated with the selected loan type; and
(c) sends a funding package for the loan to the source from the credit and loan processor via the communications network.

6. The method of claim 5 further comprising the step of providing the source with access to a status of the loan application using the credit and loan processing software program.

7. The method of claim 1 wherein the source is an automotive dealer and the loan is for an automotive vehicle.

8. The method of claim 1 wherein the applicant completes the prescreen questions using the applicant's computer.

9. The method of claim 1 wherein the source completes the prescreen questions using the source's computer.

10. The method of claim 1 wherein the applicant identification information is obtained using a scanner and transmitted to the credit and loan processor computer.

11. The method of claim 1 wherein the predetermined prescreen question is selectively determined to initially qualify the applicant for the loan without consideration of the applicant's credit score and credit history.

12. The method of claim 1 wherein the predetermined prescreen question is displayed on a display device.

13. The method of claim 2 wherein the debt to income ratio is determined without consideration of the applicant's credit score and credit history.

14. A system of expedited credit approval and lending, the system comprising:
a credit and loan processing software program that is resident on a credit and loan processor computer having a server and a data storage device, wherein the credit and loan processing software obtains predetermined identification information regarding an applicant using an input device, verifies the applicant identification information and if verified continues to process the loan application;
a display device in communication with the credit and loan processor computer for communicating a predetermined prescreen question to the applicant to initially qualify the applicant for a loan;
an input device for transmitting the applicant's answer to the predetermined prescreen question to the credit and loan processing computer, and the credit and loan processor software program compares the applicant's answer to the prescreen question to a predetermined lender criteria for the prescreen question and communicates via the communications network whether to continue with the loan application if the applicant's answer meets the predetermined lender criteria for the prescreen question and end the loan application if the applicant's answer does not meet the predetermined lender criteria, wherein the predetermined prescreen question is selectively determined to initially qualify the applicant for the loan without consideration of the applicant's credit score and credit history.

15. The system as set forth in claim 14 further comprising:
a lender computer in communication with the credit and loan processor computer via a communications network, wherein the lender provides the credit and loan processor software program the predetermined prescreen questions.

16. The system as set forth in claim 14 further comprising:
a source computer in communication with the credit and loan processor computer via a communications network to obtain income and debt information from the applicant using the credit and loan processing software program, and the credit and loan processing software program determines a debt-to-income ratio for the applicant by comparing the applicant's debt-to-income ratio to a lender's predetermined debt-to-income ratio rule for the loan and continues the loan application if the lender's predetermined debt-to-income ratio is met and ends the loan application if the lender's predetermined debt-to-income ration is not met; and
a lender having a lender computer in communication with the credit and loan processor computer via the internet and the lender provides predetermined loan types to the source by the credit and loan processing software program to continue the loan application, and the credit and loan processing software program obtains the applicant's credit report from a credit reporting agency in communication with the credit and loan processor computer and determines if the applicant's credit report meets predetermined criteria for the selected loan type and approves the loan to the applicant for the selected loan type if the applicant's credit report meets predetermined criteria for the selected loan type and denies the loan to the applicant if the predetermined criteria for the selected loan type is not met and communicates whether the loan is granted or denied to the source via the communications network.

17. The system of claim 14 wherein the applicant completes the prescreen questions using the applicant's computer.

18. The system of claim 15 wherein the source completes the prescreen questions using the source's computer.

19. The system of claim 18 wherein the source is an automotive dealer and the loan is for an automotive vehicle.

20. The system of claim 14 wherein the applicant identification information is obtained using a scanner and transmitted to the credit and loan processor computer.
